(19) United States
(12) Patent Application Publication
(10) Pub. No.: US 2014/0365866 A1
(43) Pub. Date: Dec. 11, 2014

(54) RECORDING MEDIUM, DOCUMENT PROVIDING DEVICE, AND DOCUMENT DISPLAY SYSTEM

(71) Applicant: FUJI XEROX Co., Ltd., Tokyo (JP)

(72) Inventor: Satoshi KINOSHITA, Kanagawa (JP)

(73) Assignee: FUJI XEROX Co., Ltd., Tokyo (JP)

(21) Appl. No.: 14/148,122

(22) Filed: Jan. 6, 2014

(30) Foreign Application Priority Data
Jun. 11, 2013 (JP) 2013-122589

(51) Int. Cl. G06F 17/22; H04L 29/08

(52) U.S. Cl. CPC G06F 17/2247; H04L 67/02
USPC 715/234

(57) ABSTRACT

A non-transitory computer readable medium stores a program causing a computer to function as: a display data generation unit that generates display data for each page from document data; a display data transmission unit that transmits the display data for a page corresponding to a request from a client device to the client device; a specifying information transmission unit that transmits to the client device specifying information in correlation with the display data for the requested page, the specifying information specifying the display data for a page in the document data that is previous to the requested page; and a unit that transmits to the client device the display data specified by the specifying information in response to a request that uses the specifying information from the client device.

### CROSS-REFERENCE TO RELATED APPLICATIONS

This application is based on and claims priority under 35 USC 119 from Japanese Patent Application No. 2013-122589 filed Jun. 11, 2013.

### BACKGROUND

(i) Technical Field

The present invention relates to a recording medium, a document providing device, and a document display system.

(ii) Related Art

When a document file retained by a web server or the like is displayed on a client terminal such as a smartphone, in general, a page in the document file is displayed after the document file is completely downloaded. Thus, if the size of the document file is large, it takes a long time since downloading is instructed until a first page is displayed.

A technology called “byte serving” is proposed as a scheme for addressing such an issue. In the byte serving, a web server sends a document file to a client terminal page by page. Use of the byte serving technology allows only a specific page that a user desires to display to be downloaded from the web server to be displayed. The byte serving technology also enables data for pages following the specific page to be sequentially downloaded to from the web server to a client terminal to be displayed.

There is also proposed a technology for providing only pages of a document file refined through a search from a server to a client terminal.

### SUMMARY

According to an aspect of the present invention, there is provided a non-transitory computer readable medium storing a program causing a computer to function as: a display data generation unit that generates display data for each page from document data; a display data transmission unit that transmits the display data for a page corresponding to a request from a client device to the client device; a specifying information transmission unit that transmits to the client device specifying information in correlation with the display data for the requested page, the specifying information specifying the display data for a page in the document data that is previous to the requested page; and a unit that transmits to the client device the display data specified by the specifying information in response to a request that uses the specifying information from the client device.

### BRIEF DESCRIPTION OF THE DRAWINGS

An exemplary embodiment of the present invention will be described in detail based on the following figures, wherein:

FIG. 1 illustrates an example of the configuration of a system according to an exemplary embodiment;

FIG. 2 illustrates an example of document management information;

FIG. 3 illustrates an example of the data content of a page index;

FIG. 4 illustrates an example of the data content of a search index;

FIG. 5 illustrates an example of a process procedure performed by a document providing server in the case where a client device requests an n-th page of a certain document;

FIG. 6 illustrates an example of a process procedure for creating the page index;

FIG. 7 illustrates an example of a process procedure for creating the search index;

FIG. 8 schematically illustrates an example of a display screen provided by document display software;

FIG. 9 illustrates an example of a search index according to a modification; and

FIG. 10 illustrates an example of the search index according to the modification illustrating the refine search results.

### DETAILED DESCRIPTION

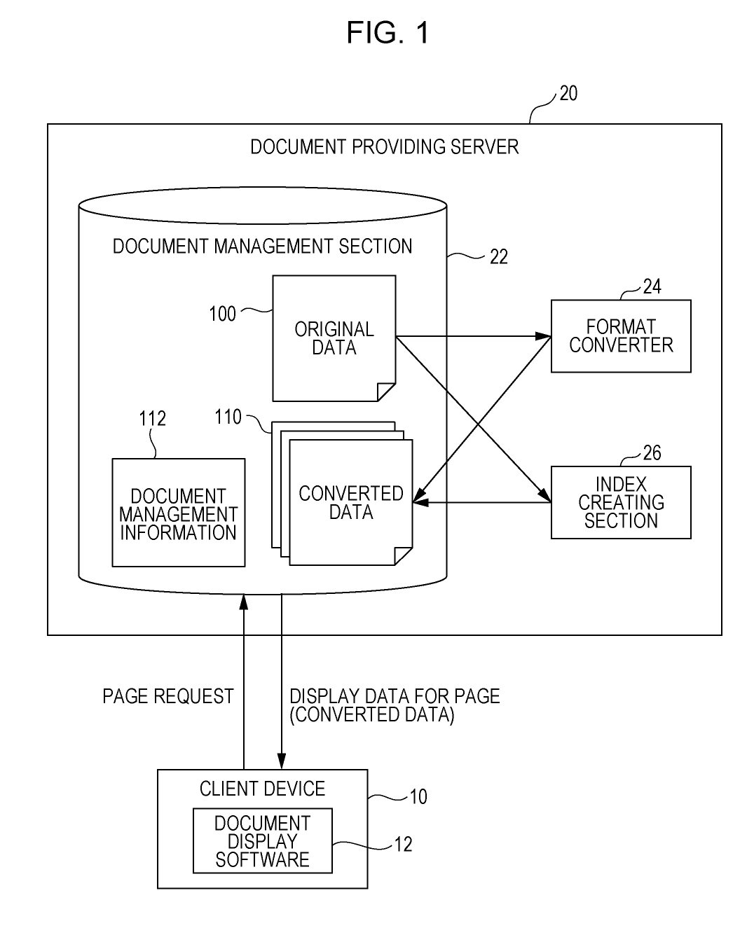

FIG. 1 illustrates an example of the configuration of a document display system according to an exemplary embodiment. In the example, the system includes a client device 10 and a document providing server 20 that are capable of communication with each other via a network such as the Internet.

The client device 10 is a terminal device operated by a user and having a computer and a display screen. The client device 10 may be any of a desktop or laptop personal computer, a cellular phone (a so-called feature phone), a smartphone, and a tablet terminal, for example. The client device 10 has document display software 12, which provides a function of displaying document data (converted data 110) provided from the document providing server 20 on a screen. In the case where the document providing server 20 provides document data using the Hypertext Transfer Protocol (HTTP), the document display software 12 is a web browser, for example. In the case where the document providing server 20 provides document data in the Portable Document Format (PDF format), the document display software 12 is software capable of handling document data in the PDF format. The HTTP and the PDF mentioned above are merely exemplary, and the document display software 12 may display document data in other file formats. Besides the function of displaying provided document data, the document display software 12 may have other functions such as editing document data.

The document providing server 20 is a server that provides document data requested by the client device 10. The document providing server 20 may be built in a web server, or operate in conjunction with a web server, for example. In this case, when the web server receives from the client device 10 an HTTP request requesting document data, for example, the document providing server 20 retrieves the document data corresponding to the request from a document management section 22, and transmits the document data to the client device 10 by way of the web server.

In the document providing server 20, the document management section 22 stores and manages a group of document data that may be provided to the client device 10. The document management section 22 according to the exemplary embodiment stores original data 100 of document data to be provided, converted data 110 that are the results of a format converter 24 converting the original data 100, and document management information 112 used to manage the converted data 110.

The file format of the original data 100 of the document data is not specifically limited. The original data 100 may be a file in a standardized file format such as the PDF, or may be a file in a non-standard format generated by a specific application such as word processor and presentation software.

The converted data 110 are document data in a format that may be displayed by the document display software 12, and include files for respective pages. That is, the original data 100 are composed of a single file with n pages (n is a natural number), and the converted data 110 corresponding to the original data 100 are composed of n files each representing a document with one page. The format of the converted data 110 may be any format that may be displayed by the document display software 12. If a standard format such as the JPEG or the PDF, for example, is used as the format of the converted data 110, the converted data 110 may be displayed by various types of the document display software 12.

The document management information 112 is management information for managing the converted data 110 divided into pages.

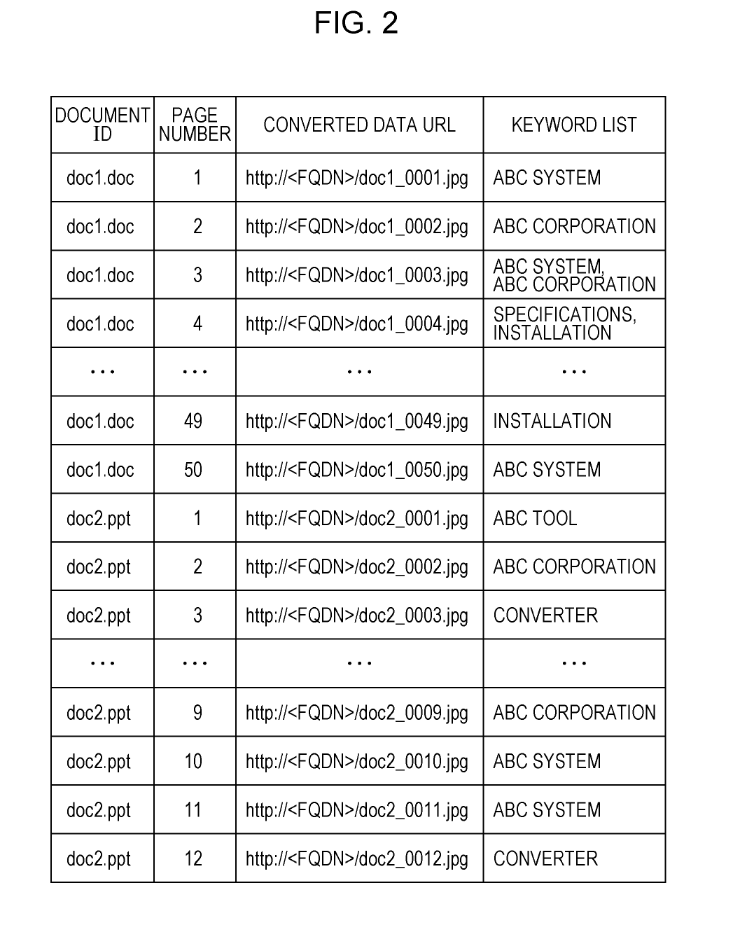

FIG. 2 illustrates an example of the document management information. Each row of the table illustrated in FIG. 2 corresponds to management information for one piece of the converted data, that is, the converted data for one page. In the illustrated example, the document management information includes a document ID, a page number, a converted data uniform resource locator (URL), and a keyword list.

The document ID is identification information for uniquely identifying the original data 100 provided in the document management section 22. In the illustrated example, the file name of the original data 100 is used as the document ID. In the case where the original data may not be uniquely specified by the file name, the path name or the URL of the original data 100 may be used as the document ID. Use of the file name, the path name, or the URL as the document ID is merely exemplary. Any document ID that may uniquely specify the individual original data 100 may be used. The page number indicates what page of the document corresponding to the document ID indicated in the “DOCUMENT ID” field the converted data 110 correspond to. The converted data URL indicates the URL of the location of storage of the converted data 110. The keyword list indicates a list of keywords extracted from the page corresponding to the converted data 110. In the illustrated example, only one or two keywords are indicated for each page in order to avoid complication. However, the actual keyword list may include a larger number of keywords.

The example of FIG. 2 illustrates management information for a group of the converted data 110 generated from a document having a file name “doc1.doc” and containing 50 pages, and a document having a file name “doc2.ppt” and containing 12 pages. In the example of FIG. 2, the converted data URL is represented by a combination of a domain name represented by <FQDN> and the file name of the converted data 110. <FQDN> is the domain name of the domain in which the converted data 110 are stored. That is, in the case where the converted data 110 are stored in the document management section 22, <FQDN> indicates the domain name of the document management section 22. It is not necessary that the converted data 110 should be stored in the document management section 22. If the URL of the converted data 110 is included in the document management information 112 possessed by the document management section 22, the document management section 22 may provide the converted data 110 to the client device 10 using the URL, wherever the converted data 110 are stored. Although the file name of the converted data 110 is generated in the form of a combination of the document ID and the page number in the example, this is merely exemplary. Although the converted data 110 are a file in the JPEG format in the example of FIG. 2, this is merely exemplary.

In the example of FIG. 2, the location of storage of the converted data 110 is represented by a URL. However, this is merely exemplary, and the location of storage of the converted data 110 may be expressed differently. The converted data 110 and the document management information 112 may be generated in advance from the original data 100 of document data to be stored and managed by the document management section 22 before a request for data is made from the client device 10 after the document data are stored in the document providing server 20.

Returning to the description of FIG. 1, the format converter 24 converts the original data 100 page by page into a specific file format for provision determined in advance to generate the converted data 110 for each page. Then, the generated converted data 110 for each page is given a file name, and stored in a domain determined in advance. The file name given may be obtained by combining the document ID of the original data 100 and the page number of the converted data 110 in accordance with rules determined in advance, for example.

The format converter 24 generates the document management information 112 for the converted data 110 corresponding to each page of the original data 100. The URL of the location of storage of the stored converted data 110 may be registered in the “CONVERTED DATA URL” field of the document management information 112. One or more keywords extracted from the page corresponding to the converted data 110 are registered in the “KEYWORD LIST” field.

An index creating section 26 generates index information to be provided to the client device 10 in correlation with the converted data 110. The index information created by the index creating section 26 includes a page index and a search index.

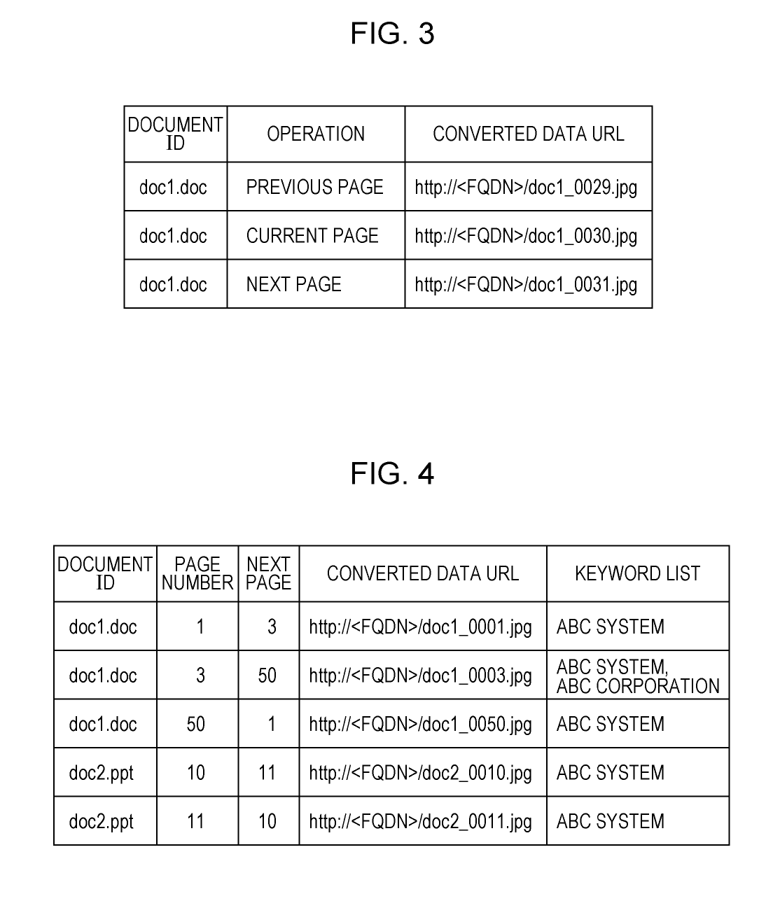

The page index is index information used to access from the converted data 110 for a certain page to pages that are previous and next to the certain page. FIG. 3 illustrates an example of the information content of the page index. The example of FIG. 3 illustrates a page index corresponding to the thirtieth page of the document “doc1.doc”. As illustrated in the drawing, the page index includes entries for the current page (in the illustrated example, the thirtieth page of the document “doc1.doc”) and one previous and one next page (in the illustrated example, the twenty-ninth and thirty-first pages). The “CURRENT PAGE” corresponds to the converted data 110 provided from the document providing server 20 to the client device 10 in response to a request from the client device 10. The previous page corresponds to the page which directly foregoes the current page. The next page corresponds to the page which directly follows the current page.

The individual entries of the page index include a document ID, an operation, and a converted data URL. The document ID indicates the document ID of the document to which the current page and the previous and next pages belong. A value in the “OPERATION” field indicates which of the current page, the previous page, and the next page each entry corresponds to. Information on the “PREVIOUS PAGE” and the “NEXT PAGE” is called up when a user interface (UI) for calling up the previous and next pages is operated from the document display software 12 of the client device 10 displaying the converted data 110 for the current page. The converted data URL is the URL of the converted data 110 for the current page, the previous page, and the next page stored in the document providing server 20.

Examples of the UI for calling up the previous page and the next page include a “PREVIOUS PAGE” button and a “NEXT PAGE” button liked to the converted data URL of the respective pages and displayed in the form of graphical user interfaces (GUIs) on a screen displaying the converted data 110.

The document display software 12 associates each of an operation for displaying the current page, an operation for displaying the previous page, and an operation for displaying the next page with the URL of the converted data for the respective pages. When any of the operations is performed, the URL associated with the operation is used to acquire the converted data 110 for the page corresponding to the operation from the document providing server 20 to display the acquired converted data 110. It is not necessary that the converted data 110 which have already been downloaded and cached in the client device 10 should be acquired from the document providing server 20 anew.

For the purpose of allowing the pages which are previous and next to the current page to be called up, it is not necessary that the page index should include a document ID or an entry for the current page.

The page index illustrated in FIG. 3 includes information on one page each previous and next to the current page. However, the number of the previous and next pages to be included in the page index is not limited to one page each. In general, the page index includes information on k pages that forego the current page and m pages that follow the current page (k and m are each a natural number determined in advance, and k may be or may not be equal to m). In this case, the document display software 12 may generate a display screen that displays GUI buttons with indications “1 page back”, “2 pages back”, . . . and “1 page ahead”, “2 pages ahead”, . . . for calling up the respective pages.

The search index created by the index creating section 26 is index information that indicates search results corresponding to search conditions sent by the user to the document providing server 20 via the document display software 12. The search index is composed of the management information for each page that matches the search conditions.

FIG. 4 illustrates an example of the search index. The example illustrates a search index created in the case where a keyword “ABC SYSTEM” is designated as the search conditions with the document management section 22 storing only two documents represented by the document management information 112 illustrated in FIG. 2. That is, pages including a character string “ABC SYSTEM” in the “KEYWORD LIST” field are extracted from the pages included in the document management information 112, and incorporated into the search index.

In the example of FIG. 4, the search index includes, for each page that matches the search conditions, a “DOCUMENT ID” of the document to which the page belongs, a “PAGE NUMBER” of the page in the document, the page number of the page next to the relevant page among the pages in the search results (“NEXT PAGE”), a “CONVERTED DATA URL” of the page, and a “KEYWORD LIST”. The values in the respective fields for the respective entries in the search index are equal to the values in the corresponding fields for the corresponding entries in the document management information 112. For example, a group of keywords included in the “KEYWORD LIST” for a certain page of a certain document in the search index is the same as a group of keywords included in the “KEYWORD LIST” for the certain page of the certain document in the document management information 112.

The “NEXT PAGE” field does not exist in the document management information 112, and thus the index creating section 26 generates the “NEXT PAGE” field. The value in the “NEXT PAGE” indicates the number of the page which is next to the relevant page among the pages in the search results. For example, the first, third, and fiftieth pages of the document “doc1.doc” meet the search conditions, and thus the “NEXT PAGE” for an entry corresponding to a page number of “1” in the search index is “3”, and the “NEXT PAGE” for an entry corresponding to a page number of “3” is “50”. The “NEXT PAGE” for an entry corresponding to a page number of “50” is “1”. This is because the “NEXT PAGE” forms a closed system for each document.

Information in the “NEXT PAGE” is used for the document display software 12 to call up the next page in the search results from a screen displaying the converted data 110 for a certain page retrieved. Similarly, information for an entry with the “PAGE NUMBER” corresponding to the “NEXT PAGE” may be utilized to call up the previous page in the search results from a screen displaying a certain page in the search results. For example, in the case where the third page of the document “doc1.doc” is displayed, it is seen that an entry having the page number “3” as the value of the “NEXT PAGE” is the first page of the document. The first page, which directly foregoes the third page in the search results, may be displayed using the converted data URL of the first page. The document display software 12 may generate GUI buttons for calling up the page which is next to (in some cases, the page which is previous to) the page currently being displayed in the search results using information in the “PAGE NUMBER” and the “NEXT PAGE” of the search index. The URL of the converted data for the “NEXT PAGE” is linked to the GUI button corresponding to the next page.

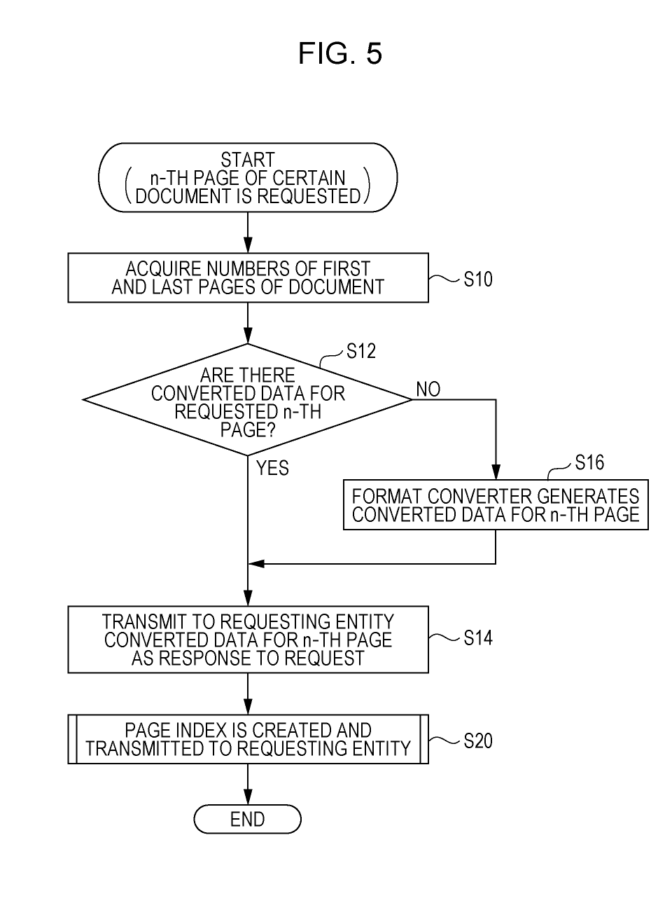

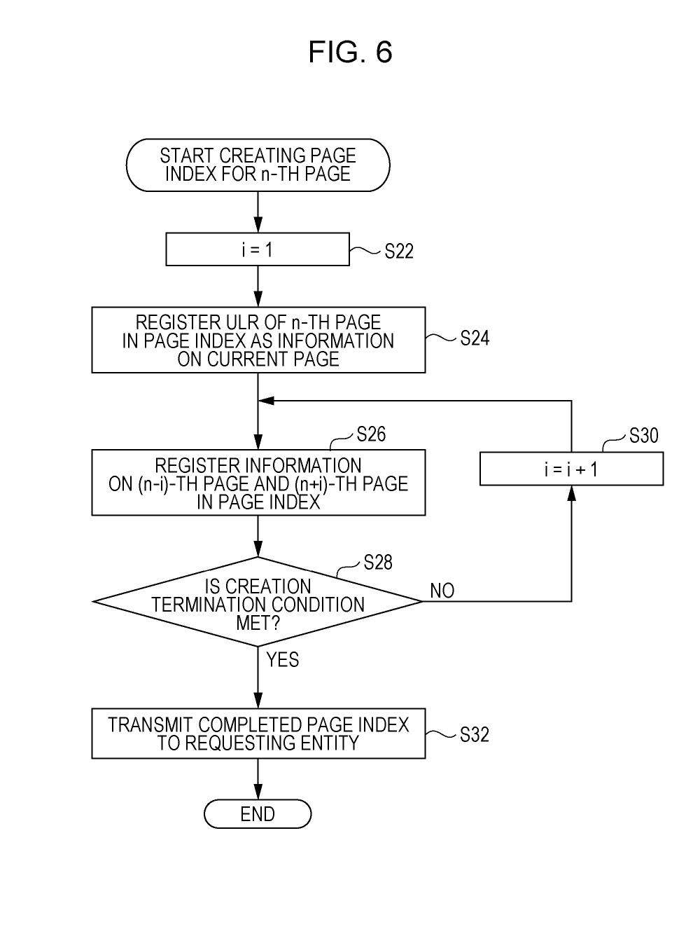

Next, an example of a process procedure for creating the page index executed by the document providing server 20 will be described with reference to FIGS. 5 and 6.

The procedure is started when a display request including information specifying a document and information (in the illustrated example, a page number n) specifying a page in the document to be displayed is received from the document display software 12 of the client device 10. In the procedure, the document providing server 20 first references the original data 100 of the document designated by the display request, and acquires the page numbers of the first and last pages of the document (S10). The acquired information is used in S28 (determination for a creation termination condition) of the procedure of FIG. 6 to be discussed later. Next, the document providing server 20 checks whether or not the converted data 110 for the page (n-th page) in the document designated as the target to be displayed already exist in the document management section 22 (S12). If such data exist, the document providing server 20 transmits the converted data 110 for the page to the document display software 12 as a response to the display request (S14).

In the case where it is determined in S12 that the converted data 110 for the requested page do not exist in the document management section 22, on the other hand, the document providing server 20 causes the format converter 24 to generate the converted data 110 for the page from the original data 100 of the document (S16). In response, the format converter 24 creates the converted data 110 for the page, extracts keywords from the page to generate a keyword list, and registers the document ID, the page number, the converted data URL, and the keyword list of the page in the document management information 112. The converted data URL is generated as a value that is unique to the converted data 110 for each page in accordance with rules determined in advance, using the name of the domain for storage of the converted data, the document ID, the page number, etc., for example. In the example, management information for a page including the document ID, the page number, the converted data URL, and the keyword list does not directly depend on a format conversion process for the page, and thus it is not necessary that the management information should be created at the same time as the converted data are created. Any of the management information and the converted data for a page may be created in advance of the other.

In the procedure of FIG. 5, after the converted data 110 for the n-th page of the requested document are transmitted to the document display software 12 which made the request in S14, the index creating section 26 creates a page index for the n-th page of the document, and provides the created page index to the document display software 12 (S20).

A detailed example of the procedure in S20 will be described with reference to FIG. 6. In the example, a page index including index information for a number of pages determined in advance back from and ahead of the n-th page is created.

In the procedure, the index creating section 26 first initializes a control variable i to 1 (S22). The control variable i is a variable that indicates the number of the page back from and ahead of the n-th page index information is to be generated for. Next, an empty page index for the n-th page of the document is created, and index information for the n-th page is first registered in the empty page index (S24). As illustrated in FIG. 3, the index information for the n-th page includes the document ID of the document to which the page belongs, the “OPERATION” for the page, that is, the “CURRENT PAGE” in this case, and the URL of the location of storage of the converted data 110 for the page. Next, the index creating section 26 creates index information for each of the (n-i)-th page and the (n+i)-th page (at this time, i=1), and adds the created index information to the page index (S26). The values of the “OPERATION” in the index information for the (n-i)-th page and the (n+i)-th page are “i PAGES BACK” and “i PAGES AHEAD”, respectively.

After S26, the index creating section 26 determines whether or not the creation termination condition is met (S28). In the case where the creation termination condition is not met, the control variable i is increased by one (S30), and the process returns to S26.

The creation termination condition is a condition for terminating the creation of a page index. The creation termination condition designates how many pages back from and ahead of the starting page (“CURRENT PAGE”=n-th page) a page index is created for, for example. The creation termination condition may be designated by the user via the document display software 12 of the client device 10. If not designated by the user, a default value is used. When S26, S28, and S30 are repeated for the designated number of pages back from and ahead of the starting page, it is determined in S28 that the creation termination condition is met, and the process is terminated. In the case where the first page of the document is reached before the creation termination condition is met, the process is no longer repeated for a direction in which the page number is decreased in S28 because there are no further previous pages. The same applies to a case where the last page of the document is reached before the creation termination condition is met.

When the page index is completed in this way, the document providing server 20 transmits the page index to the document display software 12 which made the request (S32).

In the case where the converted data 110 for a page have already been created when a request for the page is received, it is highly likely that the page index for the page has already been created. Thus, in S20, it is checked whether or not a page index for the page (that is, a page index in which the page is the current page) exists in the document management section 22, and the process of FIG. 6 is performed only in the case where such a page index does not exist.

Thus, in the example of FIGS. 5 and 6, the converted data 110 for the requested page are first provided to the document display software 12 which made the request (S14). Thereafter, the page index, which is used to call up the previous and next pages from the converted data 110, is provided to the document display software 12 when such a page index is completed.

After the page index for the n-th page is created and transmitted to the document display software 12 which made the request in the procedure of FIG. 6, the document providing server 20 may cause the format converter 24 to execute a process of generating the converted data 110 for pages which are previous and next to the n-th page. Instead, the process of generating the converted data 110 for the previous and next pages may be performed when such pages are actually requested.

In the example of FIGS. 5 and 6 described above, the converted data 110 and the management information for a page are created on demand each time a display request for the page is received from the document display software 12. However, this is merely exemplary. Instead, management information for each page of a document may be generated in advance and registered in the document management information 112 when the original data 100 of the document are registered in the document management section 22, for example, and only the converted data 110 for a page may be generated on demand. Both the management information and the converted data 110 for a page may be created in advance before a request is made.

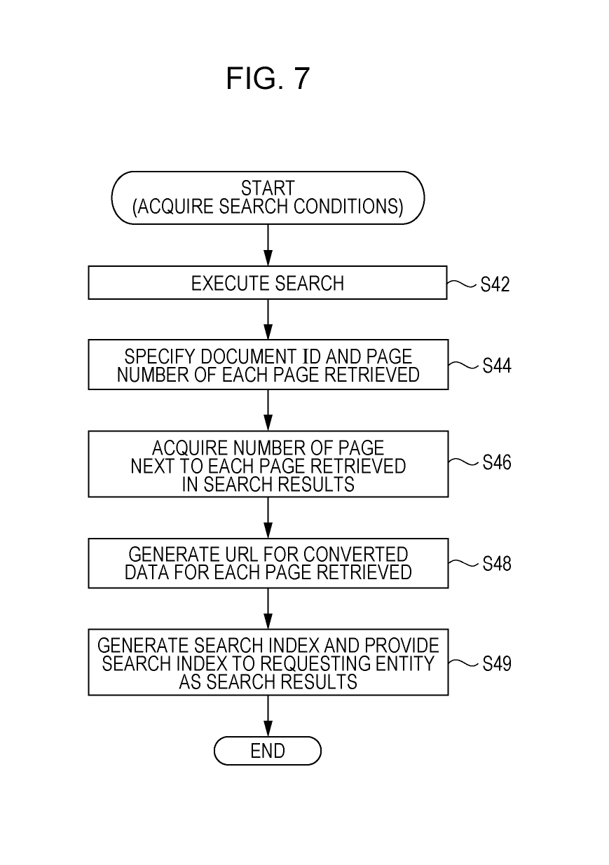

Next, an example of a process procedure for creating the search index executed by the document providing server 20 will be described with reference to FIG. 7.

In the procedure, when search conditions are acquired from the user via the document display software 12, the document providing server 20 searches for a page that matches the search conditions (S42). The search conditions may be defined by a logical formula that designates one or more keywords using an AND condition, an OR condition, etc., for example. In the case where there are original data 100 of plural documents in the document management section 22, the document providing server 20 searches for pages that meet the search conditions from a group of pages of the plural documents. In the search, a page that includes a group of keywords that meets the logical formula is searched for from the pages of the documents. The search process may be performed using the keyword list for each page of each document in the document management information 112. That is, in the case where a combination of keywords included in the keyword list for a certain page meets the logical formula defining the search conditions, the certain page may be extracted as matching the search conditions.

When pages that meet the search conditions are extracted from all the documents in the document management section 22, the index creating section 26 specifies the document ID of the document to which each page belongs and the page number of each page (S44). The index creating section 26 also acquires the keyword list for each page from the document management information 112.

The index creating section 26 obtains, for each page in the search results, the number of the page which is next to the relevant page in the search results (S46). The “NEXT PAGE” is obtained for each document. For example, in the case where the first, third, and twelfth pages are retrieved from a document A with first to twelfth pages, the “NEXT PAGE” for the first page in the search results is the third page, and the next page for the third page is the twelfth page. The next page for the twelfth page is the first page with the page number returning to the smallest number in the search results for the document A.

The index creating section 26 generates a converted data URL that indicates the location of storage of the converted data 110 for each page in the search results (S48). In an example in which the converted data URL is regularly created from the document ID, the page number, etc., the converted data URL may be obtained before the converted data 110 are actually created and stored. After that, the converted data 110 may be stored in a location indicated by the URL determined in accordance with the same rules when the converted data 110 are actually generated.

The index creating section 26 creates a search index having the structure illustrated in FIG. 4 on the basis of the information obtained in S44 to S48 (S49). Then, the created search index is sent to the document display software 12 which transmitted the search conditions.

The document providing server 20 may transmit only the search index to the document display software 12 which transmitted the search conditions. Instead, the document providing server 20 may transmit the converted data 110 for one page in the search results (for example, a page that best meets the search conditions) in addition to the search index. In the case where the converted data 110 for one page in the search results are also transmitted, the index creating section 26 may send a page index for the page to the document display software 12.

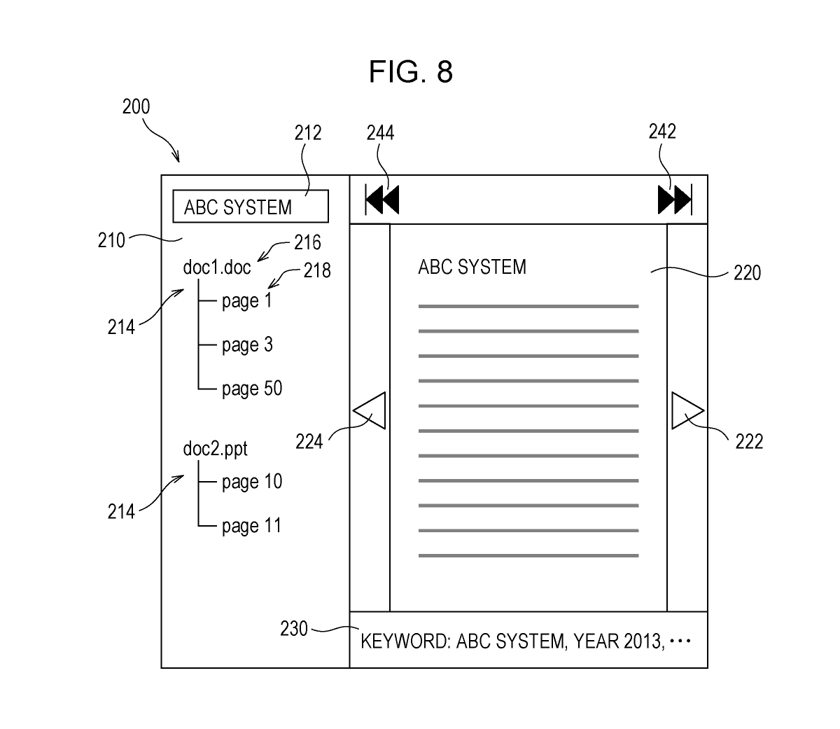

Next, an example of a document display screen generated by the document display software 12 will be described with reference to FIG. 8.

A document display screen 200 illustrated in FIG. 8 includes a search result display field 210 and a page display field 220. Search conditions input by the user are displayed in a search condition display region 212 in the search result display field 210. Search results 214 that match the search conditions are arranged for each document in the search result display field 210. The search results 214 for each document include identification information 216 (for example, the document name or the document ID) for the document and page numbers 218 of pages in the search results in the document. The illustrated example indicates that the first, third, and fiftieth pages are retrieved from the document “doc1.doc” and that the tenth and eleventh pages are retrieved from the document “doc2.ppt”. Display of the search results 214 is generated on the basis of the search index provided from the document providing server 20 in accordance with the transmitted search conditions. The search results with the two documents illustrated in FIG. 8 correspond to the search index illustrated in FIG. 4. Each of the page numbers 218 in the search results 214 is associated with the converted data URL corresponding to the relevant page number. When the user selects the page number as the target to be displayed through a click operation or the like, the document display software 12 sends an HTTP request requesting the URL associated with the page number to the document providing server 20. In response to the request, the document providing server 20 retrieves the converted data 110 for the selected page from the document management section 22, and transmits the retrieved data to the document display software 12.

A part or all of the keyword list for a relevant page may be displayed in the vicinity of each page number 218 in the search result display field 210, or in a pop-up window that is displayed in response to an operation such as placing a cursor over each page number 218. Information on the keyword list may be acquired from the search index.

In the illustrated example, links (the page numbers 218) to all the pages retrieved from the plural documents in the document management section 22 are included in the search result display field 210. The user selects a desired page from the links to have an image of the page displayed in the page display field 220. For example, after viewing a certain page of a certain document selected from the search result display field 210, the user may perform an operation such as selecting another page of another document from the search result display field 210 to have the page displayed. In the case where the number of pages retrieved is so large that all the pages may not be displayed in the search result display field 210, the search result display field 210 may be scrolled to display all the pages.

The page display field 220 displays an image of a page designated by the user as the target to be currently displayed. For example, an image of a page with a page number selected from the search result display field 210 as the target to be displayed is displayed. The image of the page to be displayed is generated from the converted data 110 for the page received from the document providing server 20.

In the illustrated example, a “next page” button 222 and a “previous page” button 224 are displayed on the left and right, respectively, of the page display field 220. The “next page” button 222 is associated with the converted data URL of the “NEXT PAGE” (or a page “1 page ahead”) in the page index acquired from the document providing server 20 in correlation with the page being displayed. Similarly, the “previous page” button 224 is associated with the converted data URL of the “PREVIOUS PAGE” in the page index. In the case where the user desires to view the page which is next to the page being displayed, the user may select the “next page” button 222 through a click operation or the like. In response to the operation, the document display software 12 sends the URL associated with the “next page” button 222 to the document providing server 20 so that the converted data 110 indicated by the URL are acquired and displayed in the page display field 220. The same process is also performed in the case where the “previous page” button 224 is selected.

In the case where a new page is downloaded and displayed by selecting the “next page” button 222 or the “previous page” button 224, a page index including the URLs of the pages which are previous and next to the new page is provided from the document providing server 20. The document display software 12 associates the converted data URLs of the previous and next pages included in the page index with the “next page” button 222 and the “previous page” button 224, respectively, in place of the URLs which have been associated with the buttons 222 and 224 so far.

In the illustrated example, a keyword list display field 230 is provided below the page display field 220. A group of keywords included in the keyword list for the page being displayed in the page display field 220 is displayed in the keyword list display field 230. The group of keywords may be acquired from the keyword list for the page in the search index, for example. The search index includes no information for pages that are not included in the search results and that are displayed in response to selection of the “next page” button 222 or the “previous page” button 224. Thus, in one example, no information is displayed in the keyword list display field 230. Instead, a keyword list for each page may be included in the page index (see FIG. 3), and information from the keyword list may be displayed in the keyword list display field 230.

In the illustrated example, a “next search result” button 242 and a “previous search result” button 244 are displayed above the page display field 220. The “next search result” button 242 is associated with the converted data URL of a page with a page number indicated as the “NEXT PAGE” of the page currently being displayed in the search index (see FIG. 4). For example, in the case where the first page of the document “doc1.doc” which is one of the search results is displayed, the “next search result” button 242 is associated with the converted data URL “http://<FQDN>/doc1_{—}0003.jpg” of the third page which corresponds to the “NEXT PAGE” of the first page in the search index of FIG. 4. Similarly, the “previous search result” button 244 is associated with the converted data URL of a page that directly foregoes the page currently being displayed in the search results, which is determined from the relationship between the “PAGE NUMBER” and the “NEXT PAGE” in the search index. Thus, when the user selects the “next search result” button 242 through a click operation or the like, the associated URL is sent to the document providing server 20, and in response, the converted data 110 corresponding to the URL and the corresponding page index are provided to the document display software 12. The document display software 12 displays the received converted data 110 in the page display field 220, and updates the URLs associated with the “next page” button 222 and the “previous page” button 224 in accordance with the page index.

FIG. 8 illustrates an example of the display screen for a case where a search has been made. In the case where the user designates the document and the page number to be displayed, in contrast, an image of the page is displayed in the page display field 220, but the search result display field 210 is blank. In this case, in addition, the “next page” button 222 and the “previous page” button 224 are activated, but the “next search result” button 242 and the “previous search result” button 244 are displayed as unselectable.

In the exemplary embodiment, as has been described above, display data (the converted data 110) are downloaded from the document providing server 20 to the client device 10 and displayed page by page. In the exemplary embodiment, in addition, a page index including information (the converted data URL) specifying display data for the pages which are previous and next to the page being displayed is used to download the page which is previous or next to the page being displayed page by page.

In the exemplary embodiment, in the case where a page retrieved in correspondence with the search conditions is displayed, pages that are previous and next to the page may be called up page by page using a page index for the page.

In the exemplary embodiment, a search index in which information (the converted data URL) specifying display data for pages that meet the search conditions is organized for each document is provided to the client side as the search results. Use of the search index allows pages that meet the search conditions to be sequentially downloaded and displayed for each individual document, or allows pages that meet the search conditions in a certain document to be displayed and pages that meet the search conditions in another document to be displayed thereafter.

In the exemplary embodiment, the search index corresponding to the search conditions acquired from the document providing server 20 by the document display software 12 includes a keyword list for each page that meets the search conditions. Thus, a refine search may be performed on the pages. That is, the document display software 12 accepts input of conditions for a refine search, obtains pages including keywords that meet the refine search conditions input by the user from the search index, and creates a search index for the refine search results including information for the obtained pages. Then, the search index for the refine search results is used to display a list of the page numbers of pages that meet the refine search conditions in the search result display field 210 in the same manner as the display of the first search results. A further refine search may be performed on the refine search results.

Next, a modification of the exemplary embodiment described above will be described. In the modification, the index creating section 26 creates a search index including information for not only pages that meet the search conditions but also pages that are previous and next to such pages in accordance with the search conditions.

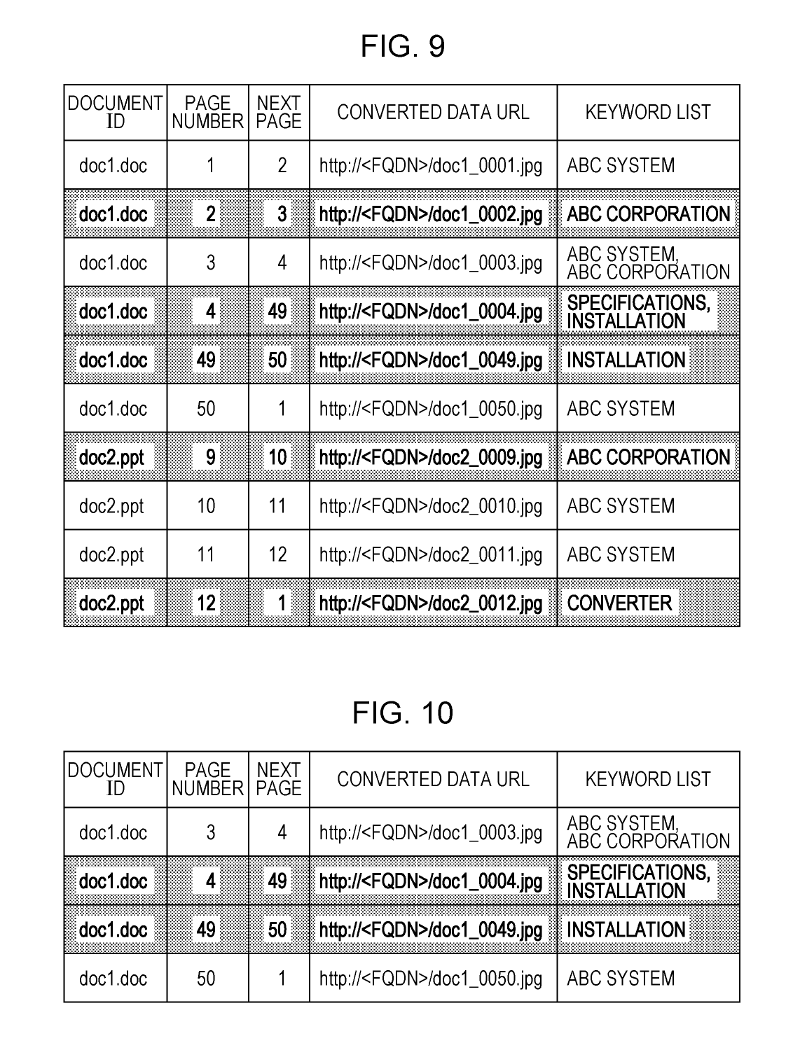

FIG. 9 illustrates a specific example of the search index according to the modification. The search index illustrated in FIG. 9 is obtained by adding information for pages that are previous and next to the pages in the search results to the search index according to the exemplary embodiment described above illustrated in FIG. 4. For example, although the first, third, and fiftieth pages of the document “doc1.doc” meet the search conditions, the search index includes not only information for the three pages but also index information for the second, fourth, and forty-ninth pages which are previous or next to such pages. The index information for the added pages includes a document ID, a page number, a next page, a converted data URL, and a keyword list as with the index information for the pages which meet the search conditions. The pieces of information are the same as the information included in the document management information 112 except for the “NEXT PAGE”.

The values in the “NEXT PAGE” field have been changed in accordance with the addition of the pages which are previous and next to the pages in the search results. For example, although the “NEXT PAGE” of the first page of the document “doc1.doc” is the third page which meets the same search conditions in the example of FIG. 4, the “NEXT PAGE” of the first page of the document “doc1.doc” is the second page which is added in the example of FIG. 9. The “NEXT PAGE” of the second page is the third page which is one of the search results. Thus, in the example of FIG. 9, the values in the “NEXT PAGE” are determined in accordance with the order of the page number in a collection including a group of pages that meet the search conditions and a group of pages that are previous and next to such pages for each document.

The document display software 12 displays the page number 218 of each page indicated in the search index in the search result display field 210 (see FIG. 8). The user may select the previous or next page in the search results in the search result display field 210 to have the page displayed in the page display field 220. In the search result display field 210, the numbers of the pages which meet the search conditions and the numbers of the pages which are previous and next to such pages may be displayed in display modes that are different from each other, such as in different colors.

The document display software 12 receives conditions for a refine search from the user, and performs a refine search in accordance with the conditions. That is, the document display software 12 references the keyword list for each page in the search index to specify pages including a keyword that meets the refine search conditions. Then, the document display software 12 creates a refined search index that includes information for pages that meet the refine search conditions.

For example, a refined search index obtained when a keyword “INSTALLATION” is designated as the refine search conditions for the search index of FIG. 9 is illustrated in FIG. 10. The refined search index illustrated in FIG. 10 includes information for the fourth and forty-ninth pages including the keyword “INSTALLATION” and the third and fiftieth pages which are previous and next to such pages, among the pages included in the search index of FIG. 9. The fifth page which follows the fourth page and the forty-eighth page which foregoes the forty-ninth page are not included in the original search index (FIG. 9), and thus not included in the refine search results. The values in the “NEXT PAGE” have been changed so as to be closed among the pages included in the refined search index.

In the exemplary embodiment, as described above, a refine search is performed on the search index including a keyword list for not only pages that meet the search conditions but also pages which are previous and next to such pages. Therefore, necessary pages are retrieved from a collection of pages also including the previous and next pages which lead to the content of description in pages that meet the search conditions.

In the example of FIG. 9, one page each previous and next to pages that meet the search conditions are added to the search index. However, two or more pages each previous and next to such pages may be added to the search index.

While an exemplary embodiment and a modification of the present invention have been described above, the exemplary embodiment and the modification are merely exemplary, and may be modified in various ways without departing from the technical scope of the present invention. In the exemplary embodiment etc. described above, for example, a keyword list for each page is provided to the document management information 112 and the search index. However, other information may be provided in place of the keyword list. That is, one role of the keyword list is to be searched in a search and a refine search, and the keyword list may be replaced with a different type of information that fulfills the role. For example, the keyword list may be replaced with information indicating the characteristics of the content of each page (for example, the frequency of appearance of each word in the page expressed with a vector).

The client device 10 and the document providing server 20 described above are implemented by causing a general-purpose computer to execute a program that represents processes of various functional modules of the devices. The computer has a circuit configuration in which, for example, a microprocessor such as a CPU, a memory (primary storage) such as a random-access memory (RAM) and a read-only memory (ROM), a secondary storage controller that controls a secondary storage such as a hard disk drive (HDD), various input/output (I/O) interfaces, network interfaces that control connection with a network such as a local area network, etc. are connected via a bus, for example. A disk drive that reads data from and/or writes data into a portable disc recording medium such as a CD, a DVD, and a Blu-ray Disc, a memory reader/writer that reads data from and/or writes data into a portable non-volatile recording medium according to various standards such as a flash memory, etc. may be connected to the bus by way of the I/O interfaces, for example. A program that describes the content of processes performed by the functional modules described above is stored in a stationary storage device such as the HDD to be installed on the computer by way of a recording medium such as a CD and a DVD or by way of a communication unit such as a network. The program stored in the stationary storage device is read by the RAM and executed by the microprocessor such as the CPU to implement the group of functional modules described above.

Elements forming the document providing server 20 described above may be distributed on plural computers, and communicate with each other to implement the processes according to the exemplary embodiment or the modification described above.

What is claimed is:

1. A non-transitory computer readable medium storing a program causing a computer to function as:
a display data generation unit that generates display data for each page from document data;
a display data transmission unit that transmits the display data for a page corresponding to a request from a client device to the client device;
a specifying information transmission unit that transmits to the client device specifying information in correlation with the display data for the requested page, the specifying information specifying the display data for a page in the document data that is previous to the requested page; and
a unit that transmits to the client device the display data specified by the specifying information in response to a request that uses the specifying information from the client device.

2. The non-transitory computer readable medium according to claim 1,
wherein the display data transmission unit transmits to the client device a page in the document data that meets search conditions received from the client device as the page corresponding to the request.

3. The non-transitory computer readable medium according to claim 2,
wherein the computer is caused to further function as a search result information transmission unit that transmits to the client device search result information including the specifying information specifying the display data for each page that meets the search conditions.

4. The non-transitory computer readable medium according to claim 3,
wherein the search result information transmitted by the search result information transmission unit further includes search characteristic information for each page that meets the search conditions.

5. The non-transitory computer readable medium according to claim 4,
wherein the search result information transmitted by the search result information transmission unit further includes specifying information specifying the display data for pages that are previous and next to each page that meets the search conditions and search characteristic information for such pages.

6. The non-transitory computer readable medium according to claim 1,
wherein the display data generation unit generates the display data for each page from the document data in advance before a request is made from the client device, and a document management unit manages the display data in correlation with identification information for the document data, a page number, and a keyword extracted from each page.

7. A document providing device comprising:
a display data generation unit that generates display data for each page from document data;
a display data transmission unit that transmits the display data for a page corresponding to a request from a client device to the client device;
a specifying information transmission unit that transmits to the client device specifying information in correlation with the display data for the requested page, the specifying information specifying the display data for a page in the document data that is previous to the requested page; and
a unit that transmits to the client device the display data specified by the specifying information in response to a request that uses the specifying information from the client device.

8. A document display system comprising:
a document providing device; and
a client device,
wherein the document providing device includes
a display data generation unit that generates display data for each page from document data,
a display data transmission unit that transmits the display data for a page corresponding to a request from a client device to the client device,
a specifying information transmission unit that transmits to the client device specifying information in correlation with the display data for the requested page, the specifying information specifying the display data for a page in the document data that is previous to the requested page, and
a unit that transmits to the client device the display data specified by the specifying information in response to a request that uses the specifying information from the client device, and
the client device includes
a unit that retains the specifying information received from the specifying information transmission unit in association with a previous page display operation for displaying a page that is previous to a page corresponding to the display data received from the display data transmission unit, and that requests the display data for the previous page from the document providing device using the specifying information in the case where the previous page display operation is received from a user.
